(19) United States
(12) Patent Application Publication
(10) Pub. No.: US 2024/0099266 A1
(43) Pub. Date: Mar. 28, 2024

(54) Tamper Resistant Locking Dog Collar

(71) Applicant: Levy O. Roberts, Weaverville, NC (US)

(72) Inventor: Levy O. Roberts, Weaverville, NC (US)

(21) Appl. No.: 18/449,406

(22) Filed: Aug. 14, 2023

Related U.S. Application Data
(60) Provisional application No. 63/377,305, filed on Sep. 27, 2022.

(51) Int. Cl. A01K 11/00; A01K 27/00; E05B 73/00

(52) U.S. Cl. CPC A01K 11/008; A01K 27/001; A01K 27/009; E05B 73/0005

(57) ABSTRACT

A tamper resistant locking dog collar includes a lock box and a collar. The lock box forms a cavity for housing a locking mechanism having a locking pin and a collar channel defined by an upper receiving plate and a lower receiving plate. The lock box includes a primary aperture and a secondary aperture for receipt of the collar therethrough. The collar is permanently secured to the lock box on a terminal collar end, and it is sized for insertion through the primary aperture and secondary aperture of the lock box. The collar includes at least one collar aperture that is sized for engaged receipt of the locking pin when the terminal collar end is inserted through the primary aperture and the secondary aperture, when in a locked configuration. In the unlocked configuration, the locking pin is disengaged from the collar aperture, permitting movement of the terminal collar end.

### RELATED APPLICATION

This application claims priority to and incorporates entirely by reference U.S. Provisional Patent Application Ser. No. 63/377,305, filed Sep. 27, 2022.

### FIELD OF THE INVENTION

This invention relates to a tamper and cut resistant locking dog collar, and more particularly, to a tamper and cut resistant locking dog collar for use with hunting dogs and configured such that the collar may not be removed by anyone other than the owner.

The tamper resistant locking dog collar may include a lock box as a protective enclosure for housing a locking mechanism and a GPS tracking device. A collar is attached to the lock box on one end, and the opposing end is configured for insertion into the lock box, where the locking mechanism may secure the collar's opposing end within the lock box. The locking mechanism may be positioned in a locked configuration, in which the collar's opposing end may not be removed from the lock box. The locking mechanism may also be positioned in an unlocked configuration, in which the collar's opposing end is free for removal from the lock box.

### BACKGROUND OF THE INVENTION

Dog collars are widely used among the general public for purposes of identifying a dog's owner and for attachment of a leash. In the field of hunting, dogs are often used for the tracking and pursuit of game, where such pursuits may often take the dogs far beyond the line-of-sight or hearing of the dog's owner. As a result, many dog owners have begun incorporating a GPS tracking device into their dogs' collars so that they may locate a dog that is no longer within line-of-sight or within hearing range of the owner. Similarly, many hikers, campers, and other outdoors enthusiasts have begun using similar GPS tracking collars to assist in locating a dog that may have become injured or lost. Casual dog owners have also begun to use GPS tracking mechanisms in attachment with a dog's collar so that they may locate a dog who has become lost or stolen. Indeed, many dog owners utilize two collars for each of their dogs: one collar including the owner's contact information and one collar including a GPS tracking device or alternative tracking means.

A growing problem is the removal of these collars and/or GPS devices by nefarious individuals intending to steal a dog and/or the dog's collar, which may include expensive GPS technology. Once the collar and/or GPS device is removed, the owner's chances of recovering the dog decrease dramatically.

### SUMMARY OF THE INVENTION

In accordance with one form of this invention, there is provided a tamper resistant locking dog collar, including a collar and a lock box. The lock box includes a locking mechanism, wherein a locking mechanism receiver is accessible on the exterior of the lock box and the locking mechanism receiver is configured for receipt of a key. The locking mechanism includes a locking pin configured for insertion into a collar aperture of a collar. The collar includes a terminal end and an attachment end, wherein the terminal end is sized for insertion through the primary aperture and secondary aperture and the attachment end may be permanently secured to the lock box. The collar includes at least one collar aperture sized for secured receipt of the locking pin. According to one embodiment, the tamper resistant locking dog collar includes a locked configuration and an unlocked configuration, wherein a key is inserted into the locking mechanism receiver to transition the locking mechanism from the locked configuration to the unlocked configuration and from the unlocked configuration to the locked configuration. The locked configuration is defined by the locking pin being securably inserted into a collar aperture of the collar, preventing the egress of the terminal collar end from the lock box. The unlocked configuration is defined by the locking pin being not securably inserted into a collar hold of the collar, allowing the egress of the terminal collar end from the lock box.

### BRIEF DESCRIPTION OF THE DRAWINGS

For a fuller understanding of the nature of the present invention, reference should be made to the following detailed description, taken in conjunction with the accompanying drawings in which:

FIG. 1 is a perspective view of a tamper resistant locking dog collar in the closed, locked position, according to one embodiment;

FIG. 2 is an isolated perspective view of the interior of a tamper resistant locking dog collar in the locked position, including an illustration of a cutaway view of the lock box along line A-A of FIG. 11, according to one embodiment;

FIG. 3 is an isolated bottom view of the lock box and the collar of a tamper resistant locking dog collar, according to one embodiment;

FIG. 4 is an isolated top view of the lock box and the collar of a tamper resistant locking dog collar, according to one embodiment;

FIG. 5 is an isolated side view of the lock box of a tamper resistant locking dog collar, according to one embodiment;

FIG. 6 is an isolated side view of the lock box of a tamper resistant locking dog collar, according to one embodiment;

FIG. 7 is an isolated perspective view of the interior of a tamper resistant locking dog collar in the locked position, including an illustration of a cutaway view of the lock box along line A-A of FIG. 11, according to one embodiment;

FIG. 8 is an isolated perspective view of the interior of the lock box of a tamper resistant locking dog collar in the locked position, including a key inserted into the locking mechanism receiver, and including an illustration of a cutaway view of the lock box along line A-A of FIG. 11, according to one embodiment;

FIG. 9 is an isolated top view of a collar of a tamper resistant locking dog collar, according to one embodiment;

FIG. 10 is a side perspective view of keys of a tamper resistant locking dog collar, according to one embodiment;

FIG. 11 is an isolated side perspective view of a tamper resistant locking dog collar, according to one embodiment;

FIG. 12 is an isolated side perspective view of a tamper resistant locking dog collar, according to one embodiment;

FIG. 13 is a perspective view of a tamper resistant locking dog collar in the open, unlocked position, according to one embodiment;

FIG. 14 is an isolated perspective view of the interior of the lock box of a tamper resistant locking dog collar in the locked position, according to one embodiment;

FIG. 15 is an isolated bottom view of the lock box of a tamper resistant locking dog collar, according to one embodiment;

FIG. 16 is an isolated top view of the lock box of a tamper resistant locking dog collar, according to one embodiment;

FIG. 17 is an isolated side view of the lock box of a tamper resistant locking dog collar, according to one embodiment;

FIG. 18 is an isolated side view of the lock box of a tamper resistant locking dog collar, according to one embodiment;

FIG. 19 is an isolated perspective view of the interior of the lock box of a tamper resistant locking dog collar in the unlocked position, according to one embodiment;

FIG. 20 is an isolated perspective view of the interior of the lock box of a tamper resistant locking dog collar in the locked position, including a key inserted into the locking mechanism receiver, according to one embodiment;

FIG. 21 is an isolated top view of a collar of a tamper resistant locking dog collar, according to one embodiment;

FIG. 22 is a side perspective view of keys of a tamper resistant locking dog collar, according to one embodiment;

FIG. 23 is an isolated side perspective view of a tamper resistant locking dog collar, according to one embodiment; and

FIG. 24 is an isolated side perspective view of a tamper resistant locking dog collar, according to one embodiment;

FIG. 25 is a top view of a cap of a tamper resistant locking dog collar, according to one embodiment;

FIG. 26 is a bottom view of a cap of a tamper resistant locking dog collar, according to one embodiment;

FIG. 27 is a side perspective view of a cap of a tamper resistant locking dog collar, according to one embodiment; and

FIG. 28 is an isolated top view of a collar of a tamper resistant locking dog collar, showing embedded filaments, according to one embodiment.

Like reference numerals refer to like reference parts throughout the several views of the drawings.

### DETAILED DESCRIPTION

Referring to the several views of the drawings, the tamper resistant locking dog collar 100 is shown and described herein.

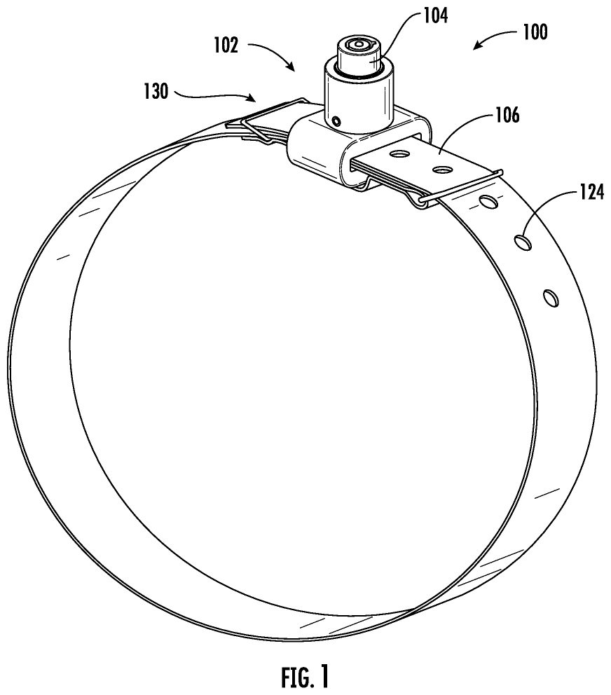

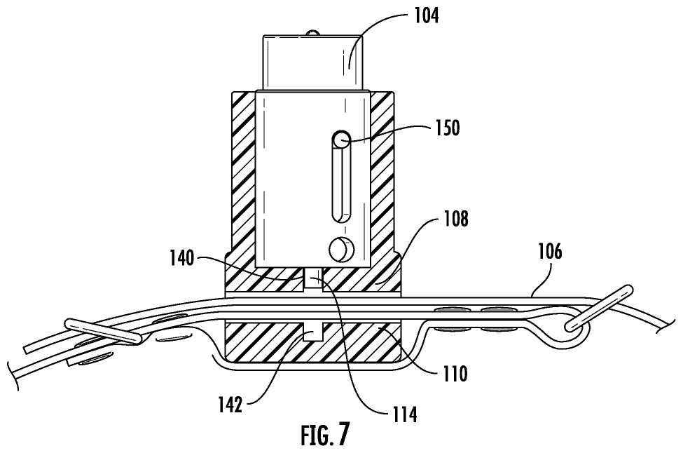

Referring initially to FIG.1, the tamper resistant locking dog collar 100 includes a collar 106 attached at a collar attachment end 130 to a lock box 102. The collar 106 includes a collar attachment end 130 and a terminal collar end 120, and the collar 106 may be composed of nylon, plastic, leather, or a synthetic blend and may include a polyurethane or other coating. The collar 106 may include at least one collar aperture 124 or may include a plurality of collar apertures 124 spaced periodically along the collar 106, wherein the collar apertures 124 may be sized for receipt of a locking pin 114 of a locking mechanism 104, as shown, for example, in FIGS. 7,8, and 2.

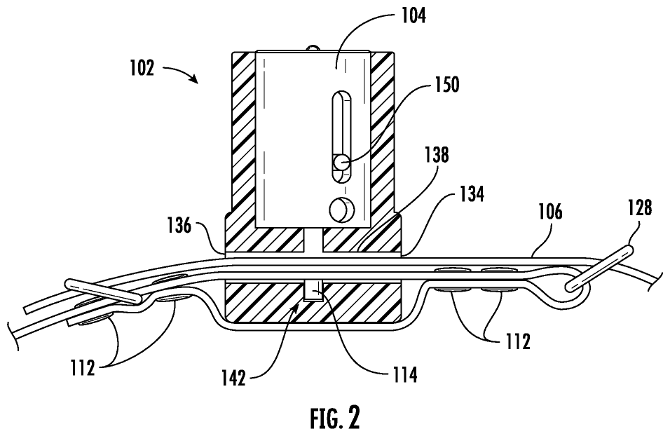

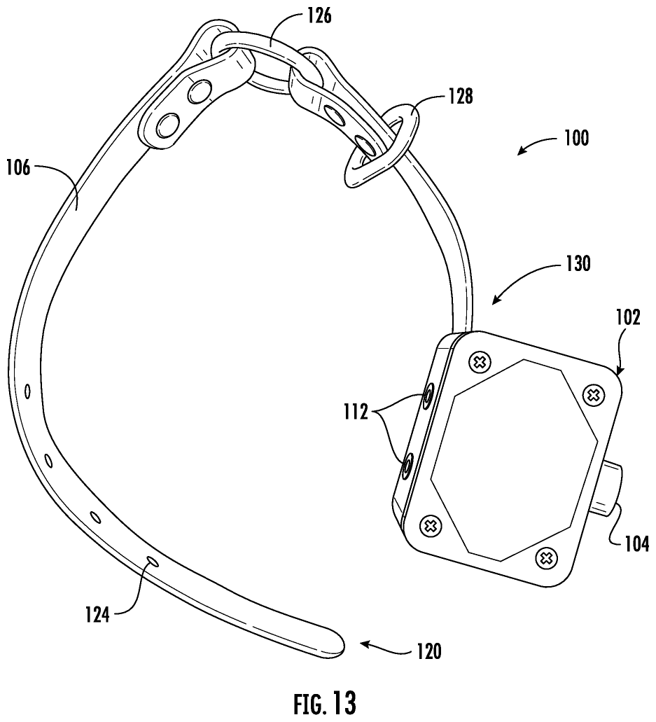

According to one embodiment, the collar attachment end 130 may be threaded through the lock box 102 and secured to a point on the collar 106 via collar securements 112, as shown, for example in FIG. 2. The collar 106 may also include one or more collar connecting rings 126 and one or more collar D-rings 128, as shown, for example, in FIG. 13.

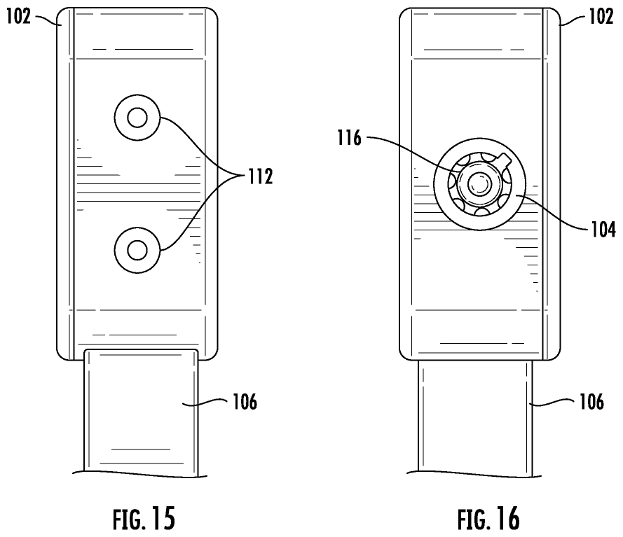

According to one embodiment, the collar 106 may be secured to the lock box 102 by one or more collar securements 112 at the collar attachment end 130 of the collar 106, as shown, for example, in FIG. 15. According to one embodiment, the collar 106 may include a collar connecting ring 126 and a collar D-ring 128.

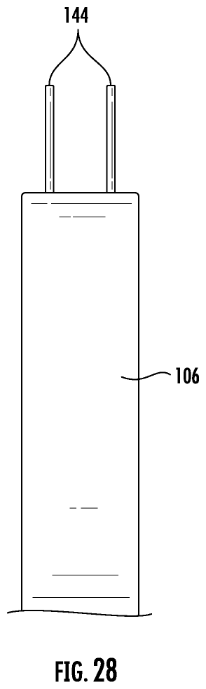

According to one embodiment, and as shown in FIG. 28, the collar 106 may be embedded with one or more filaments 144 or wires composed of metal or similar cut resistant material. The inclusion of this wire/filament prevents or inhibits the collar 106 from being cut and also extends the longevity of the collar's 106 use.

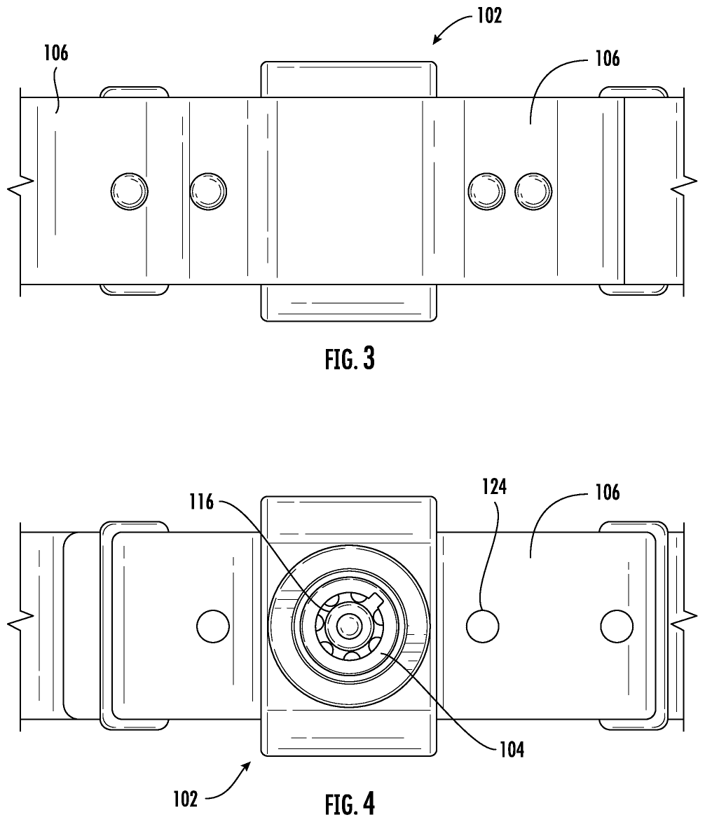

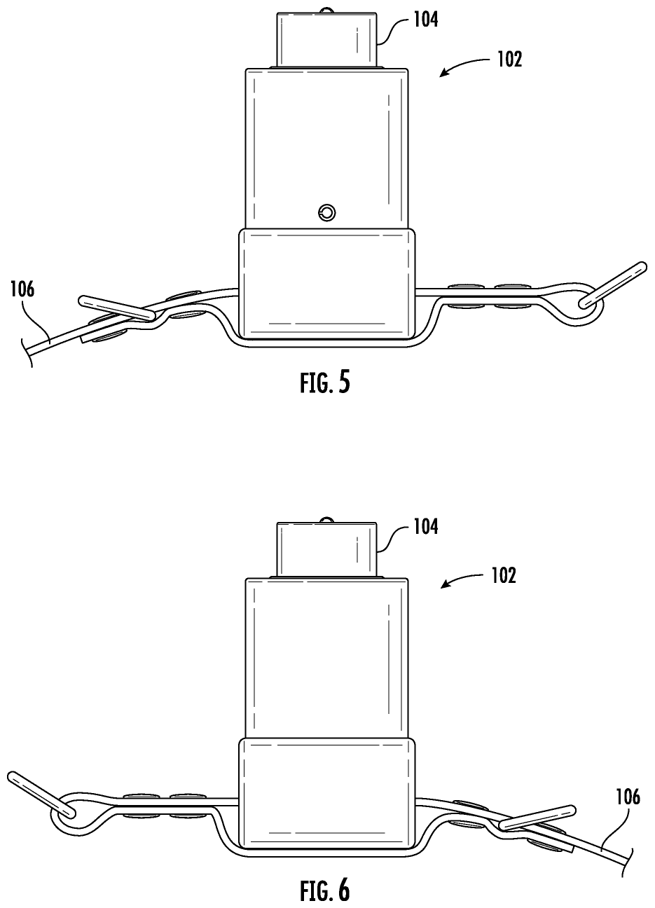

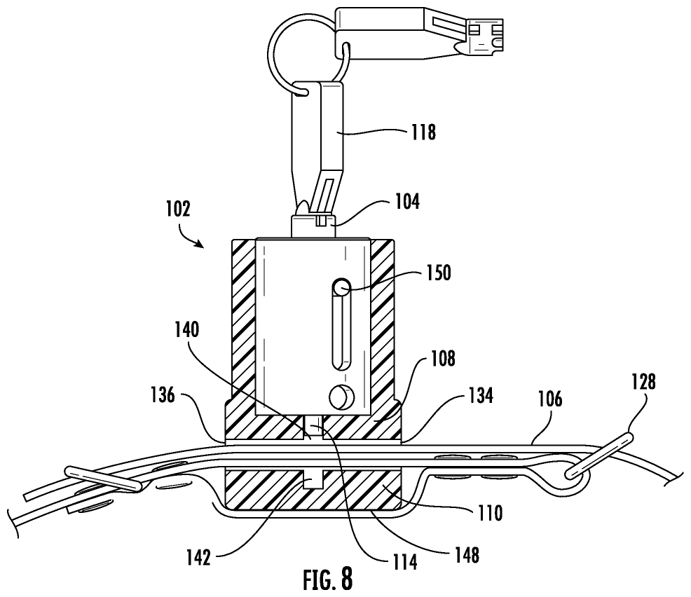

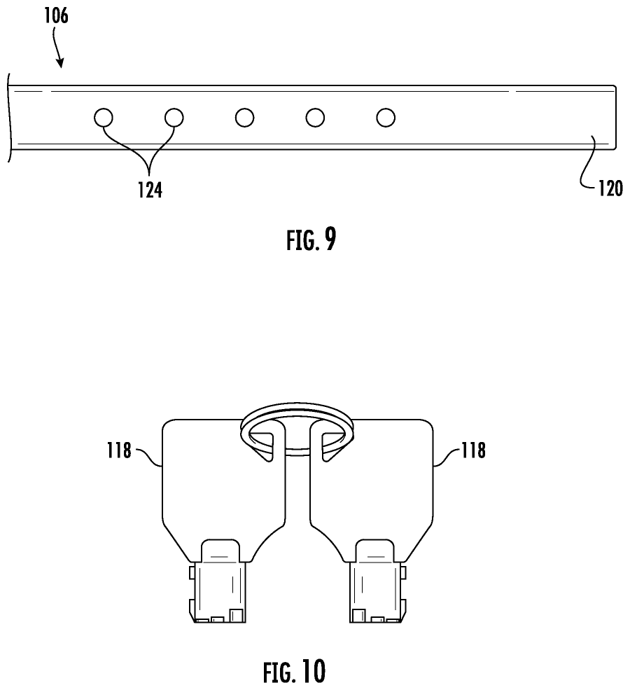

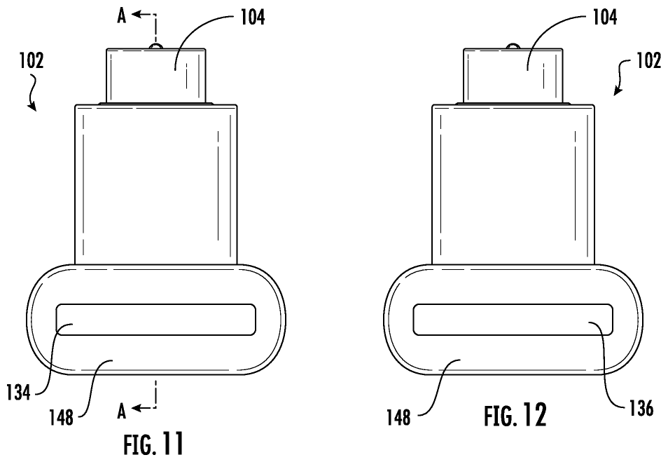

Referring now to FIGS. 1-8, and according to one embodiment, the lock box 102 includes a locking mechanism 104 contained completely or partially within the structure of the lock box 102, wherein the locking mechanism receiver 116 is accessible to a user to lock/unlock the locking mechanism via key 116. Similarly, the lock box 102 may be accessible only when the locking mechanism 104 is in the unlocked configuration, whereby the locking mechanism 104 may be removed to allow access to the lock box 102 interior. For example, the locking mechanism 104 may include a lateral locking arm 150 that extends into the lock box 102 when in the locked configuration, preventing removal of the locking mechanism 104 from the lock box 102. The lateral locking arm 150 is retracted in the unlocked configuration, allowing removal of the locking mechanism 104 from the lock box 102 and allowing access to the interior of the lock box 102.

Alternatively, the lock box 102 may be structured such that the interior of the lock box 102 is permanently inaccessible. It will be appreciated by one of ordinary skill in the art that alternative locking mechanisms may be used, where for example, a user may lock/unlock the locking mechanism 104 via alphanumeric combination, biometric, or other similar authentication system.

Referring now to FIGS. 2, 7, 8, and according to one embodiment, the interior of a lock box 102 of a tamper resistant locking dog collar 100 is shown. A locking mechanism 104 is secured to the lock box 102 such that at least a portion of the locking mechanism 104, including the locking mechanism receiver 116, extends to the exterior of the lock box 102 such that a user may access the locking mechanism receiver 116.

The lock box 102 of the tamper resistant locking dog collar 100 may include a primary aperture 134, collar channel 138, and secondary aperture 136, wherein these components are defined by the space between an upper receiving plate 108 and a lower receiving plate 110. The primary aperture 134, collar channel 138, and secondary aperture 136 are sized to allow the terminal collar end 120 and the collar 106 to pass therethrough.

The lock box 102 of the tamper resistant locking dog collar 100 may include an upper receiving plate 108 and a lower receiving plate 110 located within the interior of the lock box 102. The lower receiving plate 110 may be coplanar with the inferior lock box panel 148, such that the primary aperture 134, collar channel 138, and secondary aperture 136 are located adjacent to the lower receiving plate and inferior lock box panel 148.

The upper receiving plate 108 includes an upper receiving plate aperture 140 and the lower receiving plate 110 and inferior lock box panel 148 includes a lower receiving plate aperture 142, wherein the locking pin 114 is sized and configured to pass through the upper receiving plate aperture and the lower receiving plate aperture 142 to secure the locking pin 114 within the upper receiving plate 108 and the lower receiving plate 110 and inferior lock box panel 148, when the tamper resistant locking dog collar 100 is in the locked configuration.

In the locking configuration, the locking pin 114 of locking mechanism 104 may extend downward when in the locked configuration, whereby the locking pin 114 extends through the upper receiving plate aperture 140, the lower receiving plate aperture 142, and a collar aperture 124, thus securing a portion of the collar 106 within the lock box 102.

According to one embodiment, the locking pin 114 of locking mechanism 104 may extend downward when in the locked configuration, whereby the locking pin 114 extends through the upper receiving plate aperture 140, a collar aperture 124, and into the inferior lock box panel 148, thus securing a portion of the collar 106 within the lock box 102.

In the unlocked configuration, the locking pin 114 of locking mechanism 104 may be retracted within the locking mechanism 104 such that it is not engaged through the collar aperture 124, and the terminal collar end 120 and the collar 106 may be removed from the lock box 102.

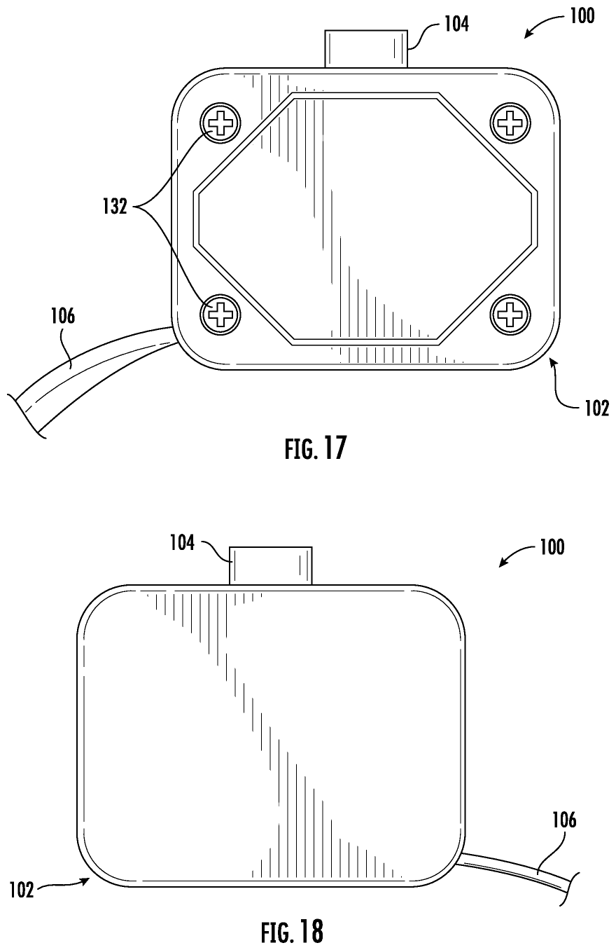

Referring now to FIG. 17, the lock box 102 may be structured with a plurality of lock box screws 132 so that the interior of the lock box 102 is accessible to a user. Alternatively, the lock box 102 may not include lock box screws 132 and be structured such that the interior of the lock box 102 is accessible only when the locking mechanism 104 is in the unlocked configuration. Alternatively, the lock box 102 may be structured such that the interior of the lock box 102 is permanently inaccessible.

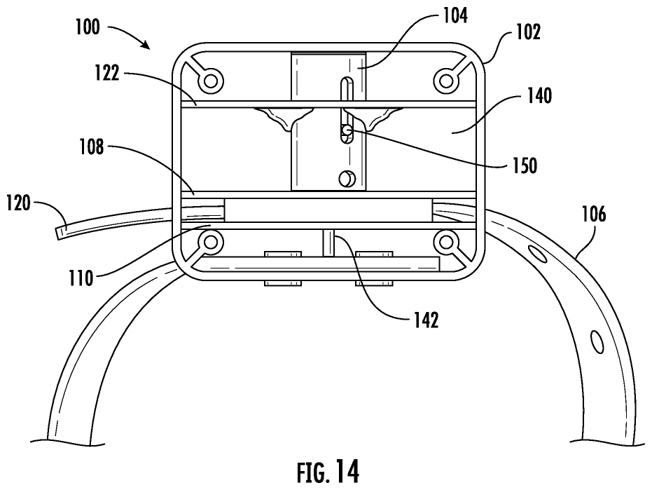

Referring now to FIGS. 14, 19, and 20, the interior of a lock box 102 of a tamper resistant locking dog collar 100 is shown, according to one embodiment. A locking mechanism 104 is secured to the lock box 102 such that at least a portion of the locking mechanism 104, including the locking mechanism receiver 116, extends to the exterior of the lock box 102 such that a user may access the locking mechanism receiver 116.

According to one embodiment and as shown in FIGS. 14, 19, and 20, the lock box 102 may contain a locking mechanism securing plate 122 attached to at least one interior surface of the lock box 102 and secured to the locking mechanism 104 for permanently positioning the locking mechanism 104 within the lock box 102.

The upper receiving plate 108 may include an upper receiving plate aperture 140 and the lower receiving plate 110 may include a lower receiving plate aperture 142. The upper receiving plate aperture 140 and the lower receiving plate aperture 142 may be positioned and configured for engaged receipt of the locking pin 114 when the tamper resistant locking dog collar 100 is transitioned from an unlocked configuration to a locked configuration.

According to one embodiment, the lock box 102 may be sized and configured to house a GPS mechanism (not shown) or other geolocation mechanism, allowing a user to locate the tamper resistant locking dog collar 100, where, for example, a user desires to locate a dog wearing the collar.

According to one embodiment, and as shown in FIGS. 14, 19, and 20, the tamper resistant locking dog collar 100 may have a locked configuration for use when the tamper resistant locking dog collar 100 is positioned on a dog and not to be removed without use of a key 118. In the locked configuration, the terminal collar end 120 of the collar 106 is inserted through the primary aperture 134, moves through the collar channel 138, which is defined by the space between the upper receiving plate 108 and the lower receiving plate 110, and exits through the secondary aperture 136. The locking pin 114 is aligned with one of the collar apertures 124 of the collar 106, and when the locking mechanism 104 is activated, the locking pin 114 extends from the locking mechanism 104, through the upper receiving plate aperture 140, through the aligned collar aperture 124, and through the lower receiving plate aperture 142, thus securing the terminal collar end 120 against removal from the lock box 102.

In the unlocked configuration, the locking pin 114 may be retracted within the locking mechanism 104 such that it is not engaged through the collar aperture 124, and the terminal collar end 120 may be removed from the lock box 102.

According to one embodiment, the lower receiving plate 110 may not include a lower receiving plate aperture 142, and in the locked configuration, the locking pin 114 is in abutment with the lower receiving plate 110 to secure the collar 106 within the lock box 102. According to an alternative embodiment, the tamper resistant locking dog collar 100 may not include a lower receiving plate, and in the locked configuration, the locking pin 114 is in abutment with the interior surface of the inferior lock box panel 148.

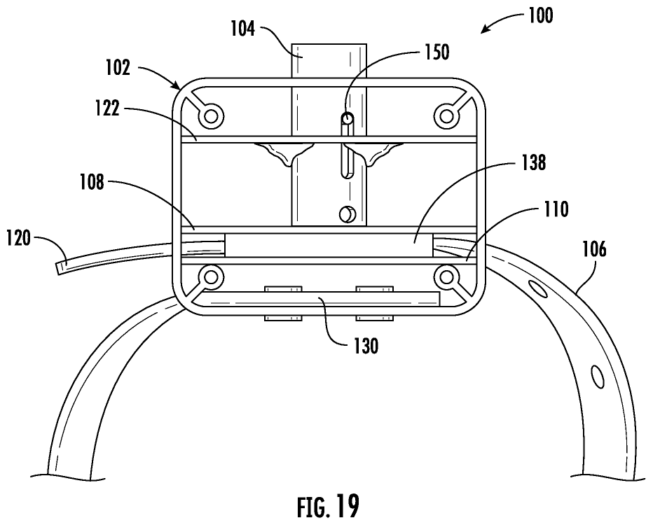

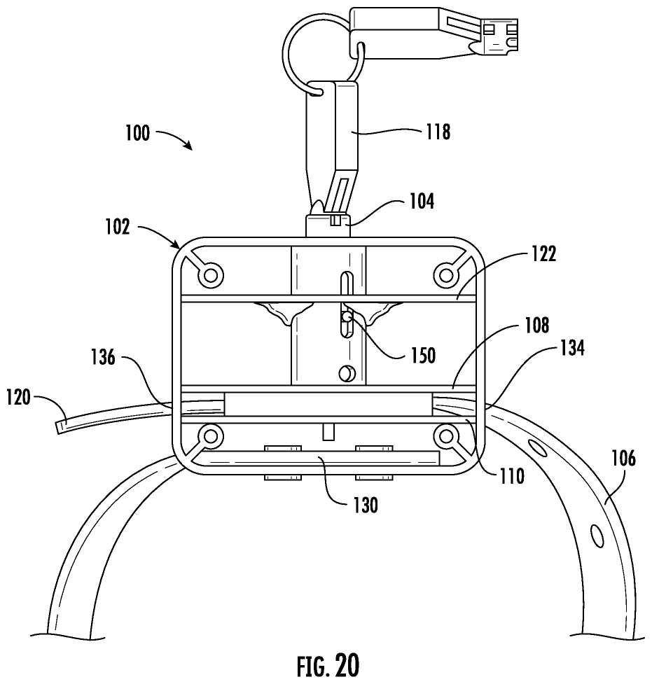

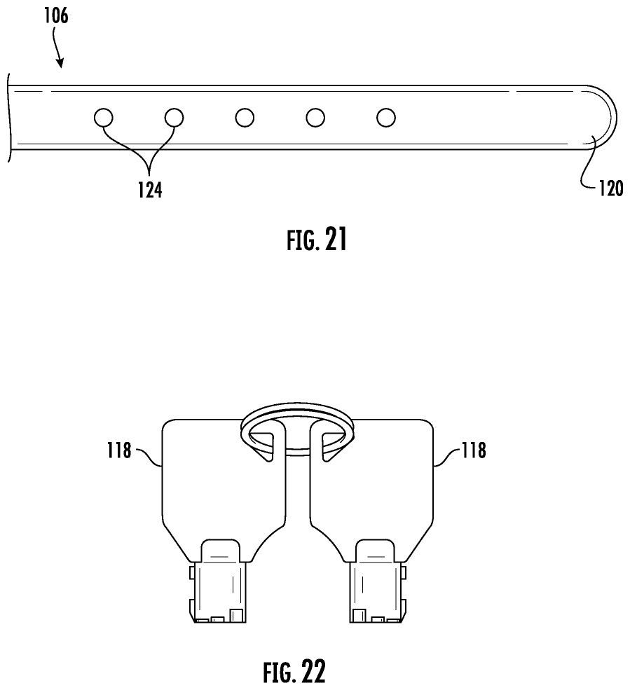

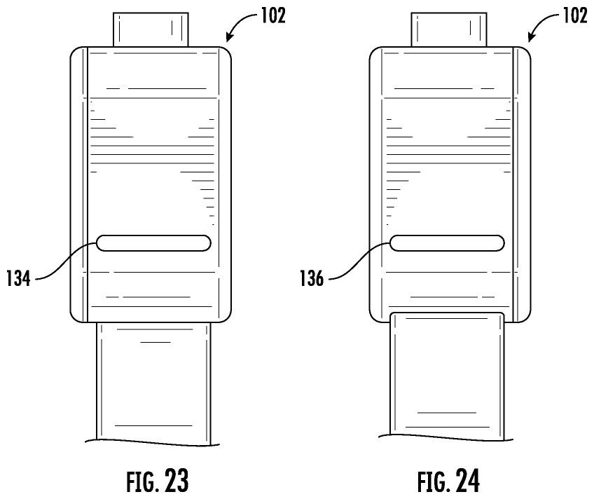

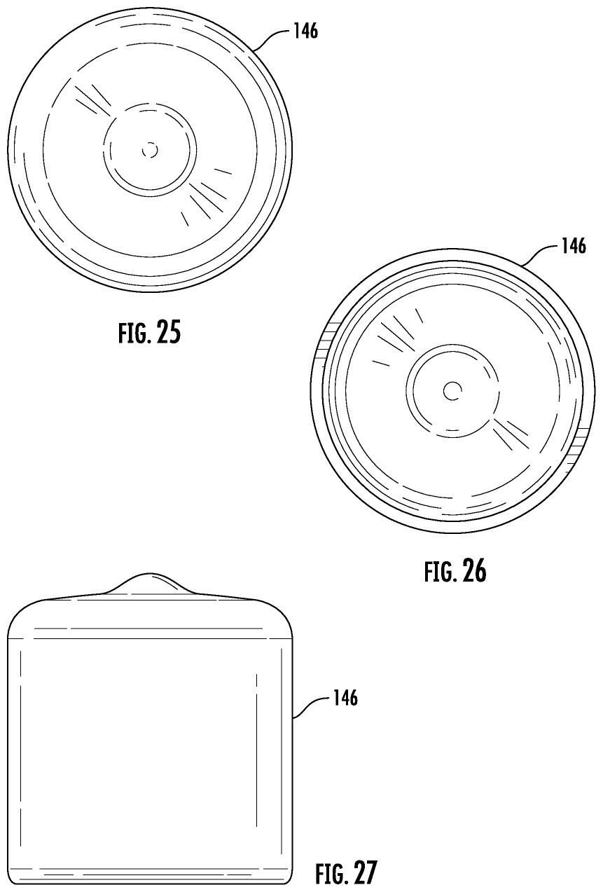

Referring now to FIG. 16, a top view of a lock box 102 of a tamper resistant locking dog collar 100 is shown, including a locking mechanism 104 secured in the lock box 102. The locking mechanism may include a locking mechanism receiver 116 configured for receipt of a key 118 for transitioning the locking mechanism 104 from the locked configuration to the unlocked configuration or from the unlocked configuration to the locked configuration, as may be seen in FIGS. 19 and 20. Referring now to FIG. 22, an exemplar key 118 is shown, for engaged receipt with the locking mechanism receiver 116 of the locking mechanism 104, where the key 118 may be rotated during engaged receipt with the locking mechanism receiver 116 to transition the locking mechanism 104 from the unlocked configuration to the locked configuration and from the locked configuration to the unlocked configuration.

It will be appreciated by one of ordinary skill in the art that the locking mechanism 104 may include an alphanumeric combination, biometric, or similar means of engaging the locked and unlocked configurations, in addition to, or as an alternative to a key 118 and locking mechanism receiver 116, without departing from the spirit or scope of the invention.

According to one embodiment, the locking mechanism 104 may be transitioned from the unlocked configuration to the locked configuration without the use of a key 116. Similarly, where an alternative locking mechanism 104 is employed (e.g., biometric or combination locking means), the locking mechanism 104 may be transitioned from the unlocked configuration to the locked configuration without the unlocking means being engaged.

While the present invention has been shown and described in accordance with several preferred and practical embodiments, it is recognized that departures from the instant disclosure are contemplated within the spirit and scope of the present invention.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. For brevity and/or clarity, well-known functions or constructions may not be described in detail herein.

The term “exemplary” is used herein to mean serving as an example, instance, or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner.

The terms “for example” and “such as” mean “by way of example and not of limitation.” The subject matter described herein is provided by way of illustration for the purposes of teaching, suggesting, and describing, and not limiting or restricting. Combinations and alternatives to the illustrated embodiments are contemplated, described herein, and set forth in the claims.

For convenience of discussion herein, when there is more than one of a component, that component may be referred to herein either collectively or singularly by the singular reference numeral unless expressly stated otherwise or the context clearly indicates otherwise. For example, components N (plural) or component N (singular) may be used unless a specific component is intended. Also, the singular forms “a,” “an,” and “the” are intended to include the plural forms as well, unless expressly stated otherwise or the context indicates otherwise.

It will be further understood that the terms “includes,” “comprises,” “including,” and/or “comprising” specify the presence of stated features, steps, operations, elements, and/or components, but do not preclude the presence or addition of one or more other features, steps, operations, elements, components, and/or groups thereof unless explicitly stated otherwise or the context clearly requires otherwise. The terms “includes,” “has” or “having” or variations in form thereof are intended to be inclusive in a manner similar to the term “comprises” as that term is interpreted when employed as a transitional word in a claim.

It will be understood that when a component is referred to as being “connected” or “coupled” to another component, it can be directly connected or coupled or coupled by one or more intervening components unless expressly stated otherwise or the context clearly indicates otherwise.

The term “and/or” includes any and all combinations of one or more of the associated listed items. As used herein, phrases such as “between X and Y” and “between about X and Y” should be interpreted to include X and Y unless expressly stated otherwise or the context clearly indicates otherwise.

Terms such as “about”, “approximately”, and “substantially” are relative terms and indicate that, although two values may not be identical, their difference is such that the apparatus or method still provides the indicated or desired result, or that the operation of a device or method is not adversely affected to the point where it cannot perform its intended purpose. As an example, and not as a limitation, if a height of “approximately X inches” is recited, a lower or higher height is still “approximately X inches” if the desired function can still be performed or the desired result can still be achieved.

While the terms vertical, horizontal, upper, lower, bottom, top, and the like may be used herein, it is to be understood that these terms are used for ease in referencing the drawing and, unless otherwise indicated or required by context, does not denote a required orientation.

The different advantages and benefits disclosed and/or provided by the implementation(s) disclosed herein may be used individually or in combination with one, some or possibly even all of the other benefits. Furthermore, not every implementation, nor every component of an implementation, is necessarily required to obtain, or necessarily required to provide, one or more of the advantages and benefits of the implementation.

Conditional language, such as, among others, “can”, “could”, “might”, or “may”, unless specifically stated otherwise, or otherwise understood within the context as used, is generally intended to convey that certain embodiments preferably or optionally include certain features, elements and/or steps, while some other embodiments optionally do not include those certain features, elements and/or steps. Thus, such conditional language indicates, in general, that those features, elements and/or step may not be required for every implementation or embodiment.

The subject matter described herein is provided by way of illustration only and should not be construed as limiting the nature and scope of the subject invention. While examples of aspects of the subject invention have been provided above, it is not possible to describe every conceivable combination of components or methodologies for implementing the subject invention, and one of ordinary skill in the art may recognize that further combinations and permutations of the subject invention are possible. Furthermore, the subject invention is not necessarily limited to implementations that solve any or all disadvantages which may have been noted in any part of this disclosure. Various modifications and changes may be made to the subject invention described herein without following, or departing from the spirit and scope of, the exemplary embodiments and applications illustrated and described herein. Although the subject matter presented herein has been described in language specific to components used therein, it is to be understood that the subject invention is not necessarily limited to the specific components or characteristics thereof described herein; rather, the specific components and characteristics thereof are disclosed as example forms of implementing the subject invention. Accordingly, the disclosed subject matter is intended to embrace all alterations, modifications, and variations, that fall within the scope and spirit of any claims that are written, or may be written, for the subject invention.

What is claimed is:

1. A tamper resistant locking dog collar comprising:
a lock box, the lock box including a locking mechanism, wherein the locking mechanism includes a locking mechanism receiver, wherein the locking mechanism receiver is accessible from the exterior of the lock box;
the lock box including a collar channel defined by a primary aperture and a secondary aperture, wherein the collar channel, the primary aperture, and the secondary aperture are sized for receipt of a terminal end of a collar;
the lock box further including an inferior lock box panel positioned opposite the collar channel from the locking mechanism, the inferior lock box panel including a lower panel receiving aperture sized and configured for receipt of the locking pin;
the locking mechanism receiver being configured to transition between a locked state and an unlocked state;
the locking mechanism further including a locking pin sized and configured for insertion into a collar aperture, wherein the locking pin is capable of being extended from the locking mechanism in the locked state or retracted into the locking mechanism in the unlocked state;
the collar including a terminal end and an attachment end;
the terminal end being sized for insertion through the primary aperture and the secondary aperture;
the collar further including at least one collar aperture sized for secured receipt of the locking pin;
the attachment end being attached to the lock box;
the tamper resistant locking dog collar being selectively operable between a locked configuration and an unlocked configuration;
the locked configuration defined by the collar being positioned within the collar channel and the locking pin inserted through a collar aperture and the locking pin being securably seated within the lower panel receiving aperture; and
the unlocked configuration defined by the locking pin being retracted into the locking mechanism.

2. The tamper resistant locking dog collar of claim 1, wherein the locking mechanism receiver is configured for receipt of a key.

3. The tamper resistant locking dog collar of claim 1, wherein the collar is embedded with at least one filament.

4. The tamper resistant locking dog collar of claim 1, wherein the interior of the lock box is accessible when the tamper resistant locking dog collar is in the unlocked configuration.

5. The tamper resistant locking dog collar of claim 1, wherein the lock box includes a GPS-enabled transponder.

6. The tamper resistant locking dog collar of claim 1, wherein the locking mechanism receiver is configured to utilize a numeric combination locking system.

7. The tamper resistant locking dog collar of claim 1, wherein the collar channel is further defined by the locking mechanism and by the inferior lock box panel.

8. A tamper resistant locking dog collar comprising:
a lock box, the lock box including a locking mechanism, wherein the locking mechanism includes a locking mechanism receiver, wherein the locking mechanism receiver is accessible from the exterior of the lock box;
the lock box including a collar channel defined by a primary aperture and a secondary aperture, wherein the collar channel, the primary aperture, and the secondary aperture are sized for receipt of a terminal end of a collar;
the lock box further including an upper receiving plate and a lower receiving plate, wherein the upper receiving plate is positioned on the same side of the collar channel as the locking mechanism and the lower receiving plate is positioned opposite the collar channel from the upper receiving plate;
the upper receiving plate including an upper receiving aperture sized and configured for receipt of the locking pin;
the lowering receiving plate including a lower receiving aperture sized and configured for receipt of the locking pin;
the locking mechanism receiver being configured to transition between a locked state and an unlocked state;
the locking mechanism further including a locking pin sized and configured for insertion into a collar aperture, wherein the locking pin is capable of being extended from the locking mechanism in the locked state or retracted into the locking mechanism in the unlocked state;
the collar including a terminal end and an attachment end;
the terminal end being sized for insertion through the primary aperture and the secondary aperture;
the collar further including at least one collar aperture sized for secured receipt of the locking pin;
the attachment end being attached to the lock box;
the tamper resistant locking dog collar being selectively operable between a locked configuration and an unlocked configuration;
the locked configuration defined by the collar being positioned within the collar channel and the locking pin inserted through the upper receiving aperture and through a collar aperture and the locking pin being securably seated within the lower receiving aperture; and
the unlocked configuration defined by the locking pin being retracted into the locking mechanism.

9. The tamper resistant locking dog collar of claim 8, wherein the collar is embedded with at least one filament

10. The tamper resistant locking dog collar of claim 8, wherein the interior of the lock box is accessible when the tamper resistant locking dog collar is in the unlocked configuration.

11. The tamper resistant locking dog collar of claim 8, wherein the lock box includes a GPS-enabled transponder.

12. The tamper resistant locking dog collar of claim 8, wherein the locking mechanism receiver is configured to utilize a numeric combination locking system

13. The tamper resistant locking dog collar of claim 8, wherein the collar channel is further defined by the upper receiving plate and by the lower receiving plate.

14. The tamper resistant locking dog collar of claim 8, wherein the upper receiving aperture and the lower receiving aperture are located along the same axis as the locking pin.

15. A tamper resistant locking dog collar comprising:
a lock box, the lock box including a locking mechanism, wherein the locking mechanism includes a locking mechanism receiver, wherein the locking mechanism receiver is accessible from the exterior of the lock box;
the lock box including a collar channel defined by a primary aperture and a secondary aperture, wherein the collar channel, the primary aperture, and the secondary aperture are sized for receipt of a terminal end of a collar;
the lock box further including an upper receiving plate, a lower receiving plate, and an inferior lock box panel, wherein the upper receiving plate is positioned on the same side of the collar channel as the locking mechanism and the lower receiving plate and the inferior lock box panel are positioned opposite the collar channel from the upper receiving plate;
the upper receiving plate including an upper receiving aperture sized and configured for receipt of the locking pin;
the lowering receiving plate including a lower receiving aperture sized and configured for receipt of the locking pin;
the inferior lock box panel including a lower panel receiving aperture sized and configured for receipt of the locking pin;
the locking mechanism receiver being configured to transition between a locked state and an unlocked state;
the locking mechanism further including a locking pin sized and configured for insertion into a collar aperture, wherein the locking pin is capable of being extended from the locking mechanism in the locked state or retracted into the locking mechanism in the unlocked state;
the collar including a terminal end and an attachment end;
the terminal end being sized for insertion through the primary aperture and the secondary aperture;
the collar further including at least one collar aperture sized for secured receipt of the locking pin;
the attachment end being attached to the lock box;
the tamper resistant locking dog collar being selectively operable between a locked configuration and an unlocked configuration;
the locked configuration defined by the collar being positioned within the collar channel and the locking pin inserted through the upper receiving aperture and through a collar aperture and the locking pin being securably seated within the lower receiving aperture and within the lower panel receiving aperture; and
the unlocked configuration defined by the locking pin being retracted into the locking mechanism.

16. The tamper resistant locking dog collar of claim 15, wherein the collar is embedded with at least one filament.

17. The tamper resistant locking dog collar of claim 15, wherein the interior of the lock box is accessible when the tamper resistant locking dog collar is in the unlocked configuration.

18. The tamper resistant locking dog collar of claim 15, wherein the lock box includes a GPS-enabled transponder.

19. The tamper resistant locking dog collar of claim 15, wherein the locking mechanism receiver is configured to utilize a numeric combination locking system.

20. The tamper resistant locking dog collar of claim 15, wherein the upper receiving aperture, the lower receiving aperture, and the lower panel receiving aperture are located along the same axis as the locking pin.
